(19) United States
(12) Patent Application Publication
(10) Pub. No.: US 2003/0160705 A1
(43) Pub. Date: Aug. 28, 2003

(54) Light activated optical parking guide

(76) Inventor: William N. Guetz, San Diego, CA (US)

Correspondence Address: WILLIAM N. GUETZ, 4750 Caroline Drive, San Diego, CA, 92115, US

(21) Appl. No.: 10/084,864

(22) Filed: Feb. 27, 2002

(51) Int. Cl. G08G 1/14

(52) U.S. Cl. 340/932.2

(57) ABSTRACT

A light activated optical parking guide includes a container, a dark tunnel, a light detector, an electrical level detector, a power switch and one or more laser pointers. The dark tunnel couples light from the garage door opener bulb to the light detector and limits ambient light. The light detector generates an electrical level which triggers a threshold when the garage door light bulb goes on. The threshold switch supplies power to one or more laser pointers, which point to a target on the vehicle driver's dashboard when vehicle arrives at the desired parking position, giving both forward-back and left-right alignment.

### BACKGROUND OF THE INVENTION

1. Field of the Invention

The present invention relates to guiding vehicles into confined parking spaces. The problem that drivers face when parking a vehicle has both forward/back and left/right components. The present invention eases the difficulty of proper vehicle positioning in order to optimize space utilization.

2. Prior Art

Guidance systems for parking vehicles include hanging balls that touch the vehicle's windshield, objects mounted on the garage floor that can be sensed by the driver and many other solutions which are referenced below. One of the inherent problems with many of these solutions are that they usually provide only forward/back feedback and do not provide left/right alignment feedback. Another common problem is that they sometimes impede the space of the garage, like the hanging ball gets in the way when the vehicle is not there. Some other solutions have overly complicated systems for sensing the presence of a vehicle.

U.S. Pat. No. 3,874,322 teaches a movable vehicle parking position indicator that moves in conjunction with the garage door. When the door lifts up, the indicator is lowered and when the door closes, the indicator retracts.

U.S. Pat. No. 4,145,681 teaches a parking guide and signaling device for cars and trucks to assist the driver parking a vehicle in a designated parking area which includes a housing section having a window in the front wall thereof which is closed by a pane of translucent sheet material through which indicia can be seen clearly when the indicia are illuminated from the rear surface of the pane by an electrical light with electrical apparatus within the housing for illuminating the pane and the housing section having pivotally mounted thereon an actuating lever biased so that the electrical apparatus is normally “off” but when the vehicle moves into a designated parking area the electrical apparatus is turned “on” and an intense beam of light illuminates the inner surface of the pane.

U.S. Pat. No. 4,218,157 teaches a visual vehicle parking aid which includes a plurality of vertically suspended position indicators to direct a person driving a vehicle into a space when normal markings are not visible.

U.S. Pat. No. 4,808,997 teaches a method of optical vehicle positioning by using laser or light emitting diode which is turned on by control circuitry which uses the reflection of a beam to determine the presence of a vehicle. The control circuitry can minimize the likelihood of interception by pedestrians, pet animals and other moving things.

U.S. Pat. No. 4,965,571 teaches a signaling method for a vehicle driver to position the vehicle which is triggered by bumper activated apparatus. The method uses green lights and red lights to indicated control signals.

U.S. Pat. No. 5,127,357 teaches a method of guiding a vehicle driver into a desired position by means of reflecting images through mirrors.

U.S. Pat. No. 5,285,205 teaches a vehicle guidance and positioning system which uses a laser beam directed over the path along which a vehicle is to be guided. The laser beam impinges on a target area located on the vehicle in such a manner that the impingement of the laser beam on the target is continuously observable by the vehicle's operator.

U.S. Pat. No. 5,343,376 teaches a laser pointer consisting of a laser module, a lens, a casing, a battery and a switch.

U.S. Pat. No. 5,406,395 teaches an optical parking alignment system which includes at least one projector located on a vehicle for projecting a respective image forwardly of the vehicle. The alignment of the vehicle is indicated when each respective image is in focus. The projector includes either a transparency and an imaging lens or a hologram and a narrow band of light source.

U.S. Pat. No. 5,617,087 teaches a method of providing guidance to a vehicle driver by means of controlling the state of a light-emitting bulb when a housing intercepts the vehicle to be parked.

U.S. Pat. No. 5,841,368 teaches a parking assist device which is triggered by the engagement of the wheels of a vehicle.

U.S. Pat. No. 5,945,907 teaches a sensing and indicating device which is mounted at a fixed location to determine the distance between the vehicle and the desired parking location. The device provides visible or audible information for the driver of the vehicle to align the vehicle within a desired space or envelope.

### SUMMARY OF THE INVENTION

The present invention is generally directed to an optical parking guide for use with a garage door opener with an automatic light that goes on when the door begins to open and stays on for a set period of time thereafter.

The Applied patent is a laser pointer whose power is controlled by the light from a garage door opener for use in parking and otherwise positioning vehicles in a limited space. A container is mounted on the translucent cover of a garage door opener light. A dark tunnel is mounted within the container so as to let light from the garage door opener light pass to a light level detector and to eliminate ambient light sufficiently enough to cause a discrete difference in the electrical output of the light detector when the garage door light is “on” as opposed to when there is only ambient light. When the electrical threshold is exceeded, power is switched “on” to one or more laser pointers. The lasers provide a visible dot which can be used to aligned a vehicle by comparing the position of the visible dot with a target on the dashboard of the vehicle, thus providing both left/right alignment and forward/back alignment. When the garage door light goes “off” the laser pointers are switched “off.”

In a first separate aspect of the invention the optical parking guide includes a light sensing element which can determine garage-door generated light from ambient light and thereby control the power to a laser pointing device. Other aspects and many of the attendant advantages will be more readily appreciated as the same becomes better understood by reference to the following detailed description.

The features of the present invention which are believed to be novel are set forth with particularity in the appended claims.

### BRIEF DESCRIPTION OF THE DRAWING FIGURES

FIG. 1 is a side view drawing of a garage door light activated optical parking guide for use with a garage door opener according to the present invention.

FIG. 2 is a drawing of the light path from the garage door light bulb to the light detector of FIG. 1 at the exclusion of sufficient ambient light.

FIG. 3 is a schematic diagram of the control circuit of the optical parking guide of FIG. 1.

### DETAILED DESCRIPTION OF THE PREFERRED EMBODIMENT OF THE INVENTION

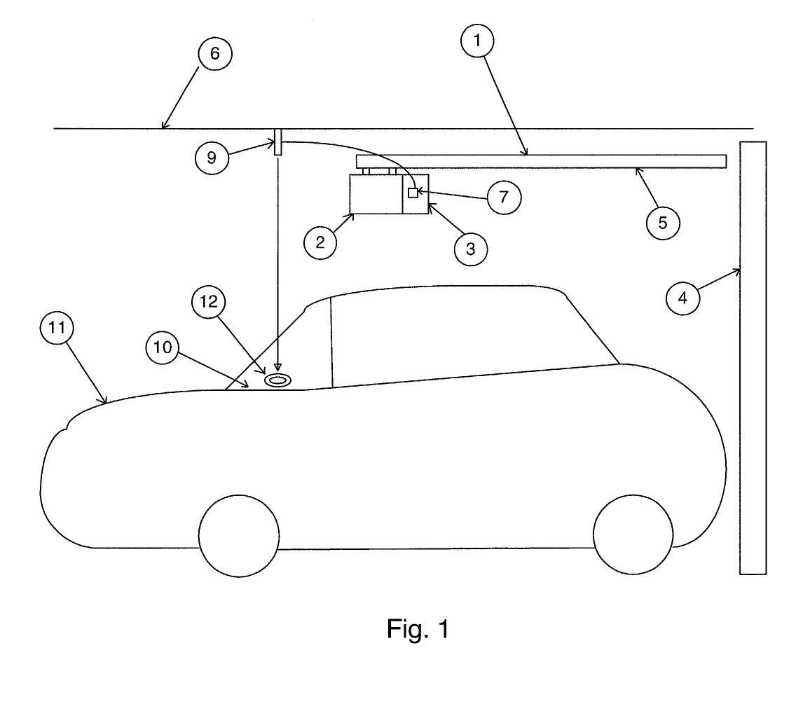

Referring to FIG. 1 a garage door opener 1 includes a motor unit 2 with a light 3 that goes on when the garage door 4 opens or closes and stays on for a period of time. The garage door 4 and opener 1 are attached to rails 5 and garage ceiling 6. When the opener light 3 goes “on” the sensor assembly 7 switches power to the one or more laser pointers 9. The laser pointers 9 generate a light beam column that shows up as a dot on the dashboard 10 of the vehicle 11. The driver of the vehicle 11 users the difference of the dot and a target 12 as guidance to provide positioning of the vehicle 11.

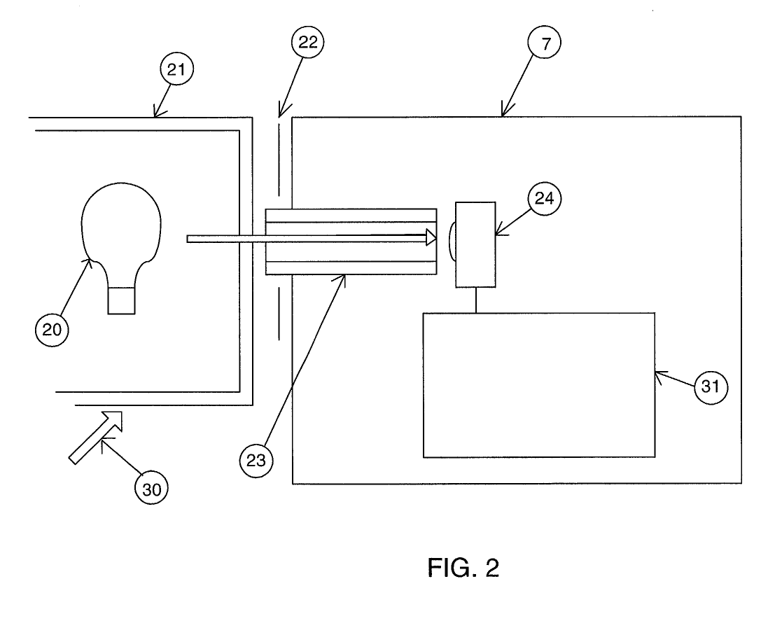

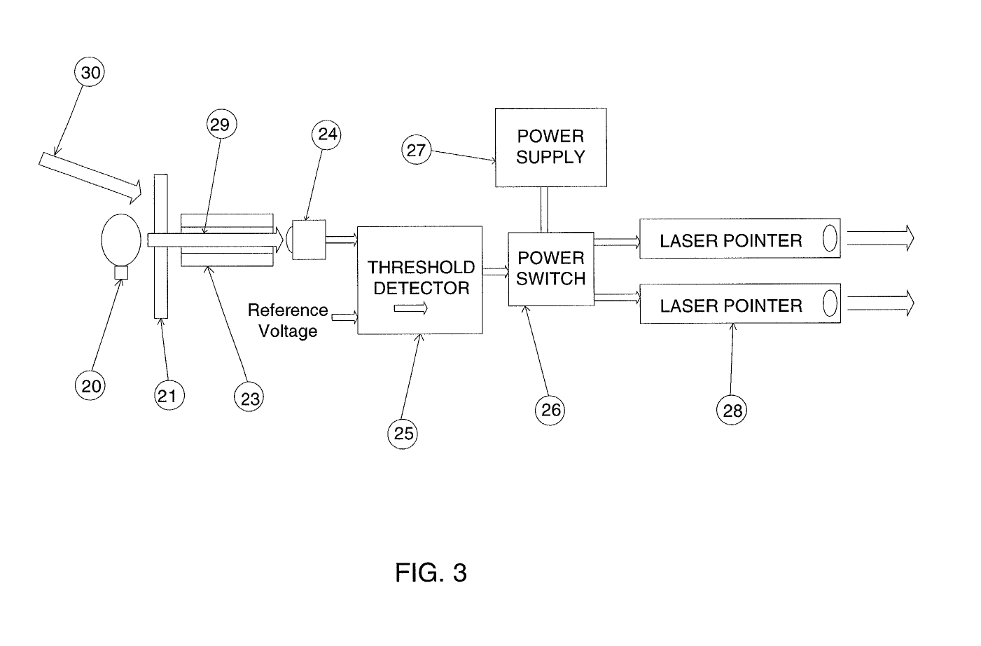

Referring to FIG. 2 in conjunction with FIG. 1 the garage door opener light consists of a light bulb 20 and a translucent cover 21. Light energy from the light bulb 20 goes through the cover 21 to the sensor assembly 7 which is mounted directly to the cover 21 with an adhesive 22 and contains a dark tunnel 23 which abuts the cover 21 and allows light at the cover 21 end of the tunnel 23 to pass to the light detector 24 end of the tunnel 23. The light detector 24 generates a voltage level that is distinguishably higher when light is emitted from the garage door opener light bulb 20 than from the unwanted ambient light 30 that leaks into the cover 21 and into the tunnel 23. The sensor assembly 7 also contains the control circuitry 31 as described in FIG. 3.

Referring to FIG. 3 in conjunction with FIG. 1 and FIG. 2 the light energy from the tunnel 23 is converted to a voltage by the light detector 24 which is compared with a reference voltage by the threshold detector 25 which switches states when the light bulb 20 goes “on.” The “on” state of the threshold detector 25 enables the power switch 26 to supply the proper current and voltage from the power supply 27 to the one or more laser pointers 28.

From the foregoing it can be seen that a light activated optical parking guide for use with a garage door opener has been described.

Accordingly it is intended that the foregoing disclosure shall be considered only as an illustration of the principle of the present process.

What is claimed is:

1. An optical parking guide which attached to the housing of a garage door light, said optical parking guide comprising:
a dark tunnel attached to a garage door light housing, and to a light level detector;
said light level detector electrically communicating with a threshold determination means for controlling the state of a power switch;
said power switch supplies the proper electrical power to a means for laser light projection;
said laser light projected to a target on a vehicle being moved into a desired position.

2. The attachment of the level detector of claim 1 to the light assembly of the garage door opener without disturbing the electrical system of the garage door opener, said attachment comprising:
a direct contact attachment to the cover of the light shield of the garage door opener light.
